(19) United States
(12) Patent Application Publication
(10) Pub. No.: US 2018/0143945 A1
(43) Pub. Date: May 24, 2018

(54) METHOD AND SYSTEM FOR DETECTING OUTLIER BASED ON MULTIPLE PIVOTS INDEX

(71) Applicant: Shenzhen University, Shenzhen (CN)

(72) Inventors: Rui Mao, Shenzhen (CN); Honglong Xu, Shenzhen (CN); Minhua Lu, Shenzhen (CN); Hao Liao, Shenzhen (CN); Ronghua Li, Shenzhen (CN); Yi Wang, Shenzhen (CN); Gang Liu, Shenzhen (CN)

(21) Appl. No.: 15/876,218

(22) Filed: Jan. 22, 2018

Related U.S. Application Data
(63) Continuation of application No. PCT/CN2016/080505, filed on Apr. 28, 2016.

(51) Int. Cl. G06F 17/18

(52) U.S. Cl. CPC G06F 17/18

(57) ABSTRACT

A method for detecting an outlier based on a multiple pivots index, comprising: a pivot selection step, of reading a data set, and selecting multiple pivots from the data set to form a pivot set (S11); an index establishment step, of calculating the distance between each object in the data set and the selected multiple pivots, using the distance as a coordinate to form multi-dimensional data space, and establishing an index with the multi-dimensional data space (S12); an outlier detection step, of dividing the index into data blocks, and performing a detection on the data blocks for outliers, block by block (S13). Further provided is a system for detecting an outlier based on a multiple pivots index.

### CROSS-REFERENCE TO RELATED APPLICATIONS

The present application is a Continuation Application of PCT application No. PCT/CN2016/080505 filed on Apr. 28, 2016, the entire contents of which are hereby incorporated by reference.

### TECHNICAL FIELD

The present invention relates to the field of computer science, and particularly to a method and a system for detecting outlier based on multiple pivots index.

### BACKGROUND

An outlier is a data point that is significantly different from the rest of the data set and the performance of which is so different from the other data points that it made the data to be suspected that it was generated by a completely different mechanism instead of simply being a random deviation. The outlier is also referred to anomaly or anomalous object. The outlier detection, is also called as anomaly detection, deviation detection or outlier mining, which detects outliers, such as TOP-n outliers or all outliers meeting the requirements, from the data set based on certain algorithms. In other words, the outlier detection is used to mine out small minority of points which are significantly different from the majority of data in the mass data.

At present, there are two typical detection algorithms with respect to outliers, including the ORCA algorithm and the iORCA algorithm.

Wherein, ORCA algorithm is a method that randomly disrupts the order of the data set, so as to obtain the time complexity which is approximately linear on average. However, in the worst case, the time complexity may be up to O(n²)! Even on average, the pruning efficiency is not yet ideal because of the slow increasing speed of the outlier degree threshold. As a result, the detection is very time-consuming in the case of a large scale data set.

The iORCA algorithm has the following deficiencies: first of all, only one single pivot is used, saving time in establishing index but in the meanwhile causing distortion of the data space and thus reducing a quality of the index, which results in insufficient pruning efficiency, secondly, iORCA algorithm detects the regions far from the pivot preferentially in order to rapidly increase the outlier degree threshold but neglects the spare regions, causing the increasing speed of the outlier degree threshold being limited. Thirdly, iORCA algorithm fails to provide a selection algorithm of pivots while the quality of the pivot is closely related to the performance of algorithm. In other words, the pivot is simply randomly selected in the iORCA algorithm, resulting in an unstable effect. Lastly, there is only one single stopping rule used in iORCA algorithm to determine whether to stop the outlier detection or not, failing to make the most of “triangle inequality” of metric space to further reduce the computing times of the distance.

### SUMMARY

### Technical Problem

Accordingly, the object of the present invention is to provide a method and a system for detecting outlier based on multiple pivots index, aiming to solve the problems of distortion of the data space and the slow speed of outlier detection caused by single pivot used in prior art.

### Technical Solution

The present invention provides a method for detecting outlier based on multiple pivots index, the method comprising:

pivot selection step comprising reading a data set, and selecting multiple pivots from the data set to form a pivot set;

index establishment step comprising calculating distances between each object in the data set and the selected multiple pivots, and using the distances as coordinates to form a multi-dimensional data space, and establishing an index with the multi-dimensional data space;

outlier detection step comprising: dividing the index into a plurality of data blocks, and performing a detection on the data blocks for outliers, block by block.

Preferably, the pivot selection step further comprises:

randomly selecting an initial reference point after reading the data set, and selecting a datum point with a farthest distance from the initial reference point;

calculating distances between each object of the data set and the datum point;

sorting the objects of the data set by the distances in an order from small to large;

dividing the data set into a plurality of segments with equal distance;

sorting the plurality of segments by quantities of the objects contained in the segments;

determining whether the quantity of the objects contained in the segments are equal or not;

when the quantities of the objects contained in the segments are unequal, adding midpoints of the quantities of respective segments into the pivot set in an order;

when the quantities of the objects contained in the segments are equal, preferentially adding a midpoint of the quantity of the segment which is closer to the initial reference point into the pivot set.

Preferably, the index establishment step further comprises:

selecting pivots of corresponding quantity from the pivot set according to the dimensionality of the multi-dimensional data to be transformed;

mapping each object in the data set as a distance from the respective pivots, so as to form a multi-dimensional data space;

mapping the multi-dimensional data space as a plurality of integer coordinate values;

calculating a Hilbert code value of each pair of the integer coordinate values with a Hilbert index mapping algorithm;

sorting the plurality of obtained Hilbert code values in an order to establish a Hilbert index.

Preferably, the outlier detection step further comprises:

dividing the Hilbert index into a plurality of data blocks, and sorting the plurality of data blocks based on the code values from spare to dense as an outlier detection order.

initializing an outlier degree threshold as 0, and reading the data set block by block in an outlier detection order.

when there is no possible for any objects in a current data set to be considered as an outlier, turning to a next data block directly.

when there is possible for any object in a current data set to be considered as an outlier, searching for a nearest neighbor from a middle object of the current data block in a spiral order and removing objects which are considered as non-outliers from the currently detected data block; updating a TOP n outlier and the outlier degree threshold and turning to the next data block after all of the objects in the current data block are processed;

outputting the TOP n outlier after all of the data blocks have been processed.

In another aspect, the present invention further provides a system for detecting outlier based on multiple pivots index, comprising:

a pivot selection module, configured to read a data set and select a multiple pivots from the data set to form a pivot set.

an index establishment module, configured to calculate a distance between each object in the data set and the selected multiple pivots, and use the distances as a coordinates to form a multi-dimensional data space, and establish an index with the multi-dimensional data space;

an outlier detection module, configured to divide the index into a plurality of data blocks, and perform a detection on the data blocks for outliers, block by block.

Preferably, the pivot selection module is further configured for:

randomly selecting an initial reference point after reading the data set, and selecting a datum point with a farthest distance from the initial reference point;

calculating distances between each object of the data set and the datum point;

sorting the objects of the data set by the distances in an order from small to large;

dividing the data set into a plurality of segments with equal distance;

sorting the plurality of segments by quantities of the objects contained in the segments;

determining whether the quantity of the objects contained in the segments are equal or not;

when the quantities of the objects contained in the segments are unequal, adding midpoints of the quantities of respective segments into the pivot set in an order;

when the quantities of the objects contained in the segments are equal, preferentially adding a midpoint of the quantity of the segment which is closer to the initial reference point into the pivot set.

Preferably, the index establishment module is specifically configured for:

selecting pivots of corresponding quantity from the pivot set according to the dimensionality of the multi-dimensional data to be transformed;

mapping each object in the data set as a distance from the respective pivots, so as to form a multi-dimensional data space;

mapping the multi-dimensional data space as a plurality of integer coordinate values;

calculating a Hilbert code value of each pair of the integer coordinate values with a Hilbert index mapping algorithm;

sorting the plurality of obtained Hilbert code values in an order to establish a Hilbert index.

Preferably, the outlier detection module is specifically configured for:

dividing the Hilbert index into a plurality of data blocks, and sorting the plurality of data blocks based on the code values from spare to dense as an outlier detection order.

initializing an outlier degree threshold as 0, and reading the data set block by block in an outlier detection order.

when there is no possible for any objects in a current data set to be considered as an outlier, turning to a next data block directly.

when there is possible for any object in a current data set to be considered as an outlier, searching for a nearest neighbor from a middle object of the current data block in a spiral order and removing objects which are considered as non-outliers from the currently detected data block; updating a TOP n outlier and the outlier degree threshold and turning to the next data block after all of the objects in the current data block are processed;

outputting the TOP n outlier after all of the data blocks have been processed.

### Beneficial Effect

In order to reduce the data space distortion, the technical solution provided by the present invention selects multiple pivots from the data set and then establishes an index with little time consumption (with respect to the total time consumption of outlier detection). In order to more rapidly increase the outlier degree threshold, the spare regions of the data set, including the remote region and other spare region, are detected preferentially. In order to improve the stability of the performance of the algorithm, a pivot selection algorithm in approximate dense region is provided, so that pivots with a better quality may be selected in a short time. In order to further reduce the calculating times of the distance and accelerate the outlier detection, multiple pruning rules are used to exclude the non-outliers and non k-nearest neighbor objects. The technical solution provided by the present invention establishes an index by calculating the distances between each of the selected multiple pivots and the global data set, avoiding the data space distortion caused by single pivot; furthermore, the preferential detection of the spare regions of the data set can increase the outlier degree threshold more rapidly and improve the speed of the outlier detection.

### BRIEF DESCRIPTION OF THE DRAWINGS

FIG. 1 is a flow diagram of a method for detecting outlier based on multiple pivots index according to one embodiment of the present invention;

FIG. 2 is a detailed flow diagram of step S11 as shown in FIG. 1 according to one embodiment of the present invention;

FIG. 3 is a detailed flow diagram of step S12 as shown in FIG. 1 according to one embodiment of the present invention;

FIG. 4 is a detailed flow diagram of step S13 as shown in FIG. 1 according to one embodiment of the present invention.

FIG. 5 is an internal structural diagram of a system 10 for detecting outlier based on multiple pivots index according to one embodiment of the present invention.

### DETAILED DESCRIPTION

In order to make the objects, the technical solution and the advantages of the present invention more apparent, the present invention will be further described in conjunction with the drawings and embodiments. It is to be appreciated that the embodiments described herein merely intends to interpret the present invention, but not limit the present invention.

The terms referred to in the context of the present invention as well as the interpretations thereof are illustrated as follows:

outlier degree: the outlier degree of an object represents the degree of the object distant from the group. Generally, the average value of the distance between the object and the k-nearest neighbor or the distance between the object and kth nearest neighbor is regarded as the outlier degree;

data block: a unit of the outlier detection, consisting of a plurality of objects in the data set. For example, a thousand objects together are generally considered as a data block;

outlier degree threshold: the outlier degree of the nth outlier of TOP n outliers;

spiral order: for example, there is an index sequence 1, 2, 3, 4, 5, 6, 7, 8, 9, 10. Assuming that the index sequence starts at 5, the spiral order thereof would be 5, 4, 6, 3, 7, 2, 8 , . . . , or 5, 6, 4, 7, 3, 8, 2 , . . . Namely, one anterior number followed by one posterior number, and so on;

quantity midpoint: being a middle object based on quantity, in which the quantity of objects larger than said middle object (midpoint) and the quantity of objects less than said object (midpoint) are equal, or with a difference not larger than 1.

The embodiments of the present invention provide method for detecting outlier based on multiple pivots index, the method mainly includes the following steps:

S11, pivot selection step: reading a data set, and selecting multiple pivots from the data set to form a pivot set;

S12, index establishment step: calculating the distances between each object in the data set and the selected multiple pivots, and then using the distances as coordinates to form a multi-dimensional data space, and establishing an index with the multi-dimensional data space;

S13, outlier detection step: dividing the index into a plurality of data blocks, and performing a detection on the data blocks for outliers, block by block.

The method for detection outlier based on multiple pivot index provided by the present invention establishes an index by selecting multiple pivots, and calculating the distances between each of the selected multiple pivots and the global data set, avoiding the data space distortion caused by a single pivot, preferentially detecting all of the spare areas in the data set, increasing the outlier degree threshold more rapidly and improving the outlier detection speed.

The method for detecting outlier based on multiple pivots index provided in the present invention will be further detailed described as below.

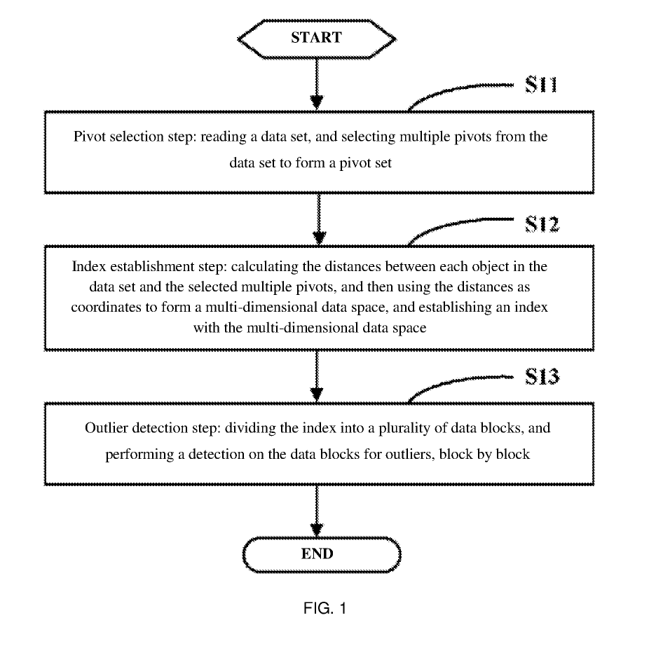

Referring to FIG. 1, shown is the flow diagram of the method for detecting outlier based on multiple pivots index according to one embodiment of the present invention.

Step S11, pivot selection step: reading a data set, and selecting multiple pivots from the data set to form the pivot set.

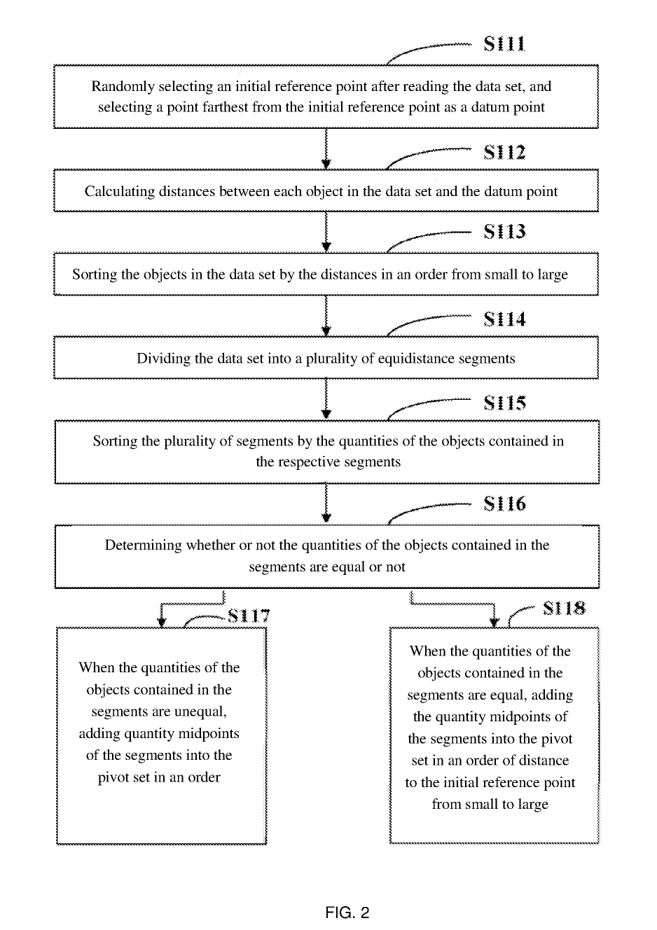

In the embodiment, the pivot selection step S11 specifically includes sub-steps S111-S118, as shown in FIG. 2.

Referring to FIG. 2, shown is a detailed flow diagram of step S11 as shown in FIG. 1 according to one embodiment of the present invention.

Step S111, randomly selecting an initial reference point after reading the data set, and selecting a point farthest from the initial reference point as a datum point.

Step S112, calculating distances between each object in the data set and the datum point.

Step S113, sorting the objects in the data set by the distances in an order from small to large.

Step S114, dividing the data set into a plurality of equidistance segments.

Step S115, sorting the plurality of segments by the quantities of the objects contained in the respective segments.

Step S116, determining whether or not the quantities of the objects contained in the segments are equal or not.

Step S117, when the quantities of the objects contained in the segments are unequal, adding quantity midpoints of the segments into the pivot set in an order.

Step S118, when the quantities of the objects contained in the segments are equal, adding the quantity midpoints of the segments into the pivot set in an order of distance to the initial reference point from small to large.

In the embodiment, equidistance division is applied to divide the data set according to an equal distance increment over the distance between the datum point to the object with farthest distance from the datum point. Assuming that the farthest distance is d_{f,}, and n segments are desired, then the data set may be divided at the points having distance of d_{f}/n, 2df/n, . . . , (n-1)d_{f}/n from the datum point respectively, so that the data set is divided into n segments with equal distance but the object quantity of the respective segments may be unequal. The method for determining the dense region is to count the object quantity of each segment firstly, then sort the segments by the counted object quantity, wherein the segment with larger object quantity is regarded as a candidate region of the pivot selection.

In the embodiment, a temporary reference point is randomly selected as the initial reference point after reading the data set, and an object with a farthest distance from the initial reference point is searched and considered as the datum point. Distances between each object in the data set and the datum point are then calculated, and the objects are sorted by the distances from small to large. By using the method of “equidistant division plus quantity midpoint” to pick out the quantity midpoints of the respective segments and add them into a pivot candidate set. The object quantity of the respective segments is calculated and sorted in an order from large to small. The segments which have equal object quantity are being compared to obtain the closest segment to the reference point, and the quantity midpoint of the closest segment is then being considered as the first pivot. When the segments have an equal object quantity, then the segment midpoint which is closer to the pivot is preferentially selected as a pivot.

In the embodiment, it should be noted that in order to enable the pivot candidate set to have sufficient pivots, the scale thereof (i.e. the quantity of the segments) should be larger than the quantity of the pivots to be selected. Generally, for a better selection quality, the quantity of the segments is at least twice of the quantity of the pivots. Furthermore, if a sub-set of the data set is used to select the pivots, the scale thereof shall not be too small to lower the quality of the pivots. Generally, one data block is preferred, but more data blocks may be used when there are many pivots.

Referring to FIG. 1, shown is step S12, index establishment step: forming a multi-dimensional data space with the selected multiple pivots, and establishing an index with the multi-dimensional data space.

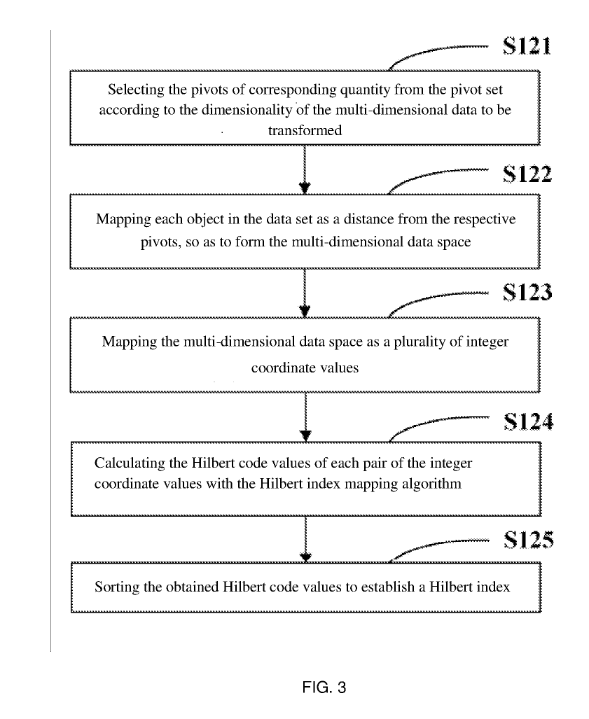

In the embodiment, the step of index establishment S12 specifically includes sub-steps S121-S125, as shown in FIG. 3.

Referring to FIG. 3, shown is a detailed flow diagram of step S12 as shown in FIG. 1 according to one embodiment of the present invention.

Step S121, selecting the pivots of corresponding quantity from the pivot set according to the dimensionality of the multi-dimensional data to be transformed.

Step S122, mapping each object in the data set as a distance from the respective pivots, so as to form the multi-dimensional data space.

Step S123, mapping the multi-dimensional data space as a plurality of integer coordinate values.

Step S124, calculating the Hilbert code values of each pair of the integer coordinate values with the Hilbert index mapping algorithm.

Step S125, sorting the obtained Hilbert code values to establish a Hilbert index.

In the embodiment, after reading the data set, the pivots with a corresponding quantity are selected by pivot selection algorithm according to the dimensionality of the multi-dimensional data to be converted, and each of the objects in the data set is mapped as a distance from the respective pivots and therefore form a multi-dimensional data space (i.e. real coordinate value). Next, the real coordinate values are mapped as the integer coordinate values, and then the Hilbert index mapping algorithm is applied to directly calculate the Hilbert code values of each pair of the integer coordinate values. As such, encoding of the object of the metric space is achieved. After that, those code values are sorted and therefore the Hilbert index is established.

Referring to FIG. 1, in step S13, outlier detection step includes dividing the index into a plurality of data blocks and performing a detection on the data blocks for outlier, block by block.

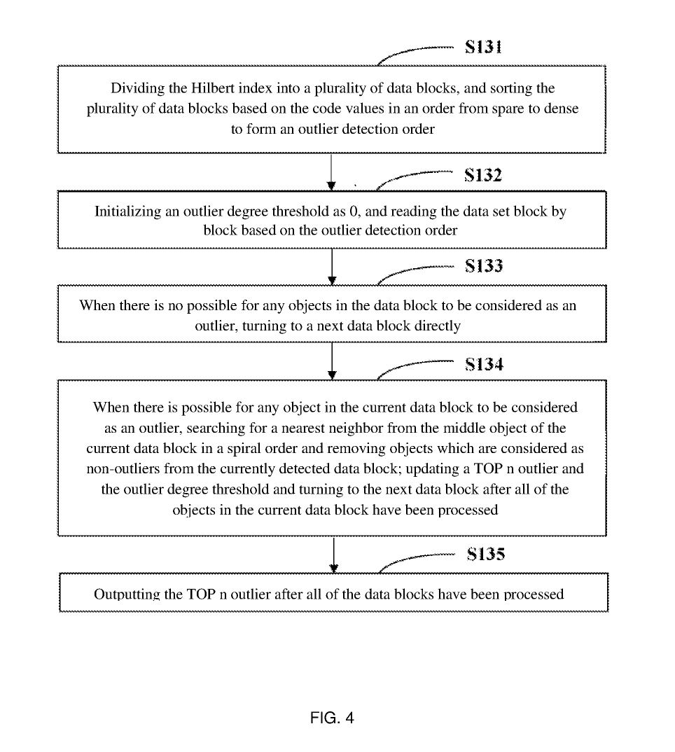

In the embodiment, the outlier detection step S13 specifically includes sub-steps S131-S135, as shown in FIG. 4.

Referring to FIG. 4, shown is a detailed flow diagram of step S13 as shown in FIG. 1 according to one embodiment of the present invention.

Step S131, dividing the Hilbert index into a plurality of data blocks, and sorting the plurality of data blocks based on the code values in an order from spare to dense to form an outlier detection order.

Step S132, initializing an outlier degree threshold as 0, and reading the data set block by block based on the outlier detection order.

Step S133, when there is no possible for any objects in the data block to be considered as an outlier, turning to a next data block directly.

Step S134, when there is possible for any object in the current data block to be considered as an outlier, searching for a nearest neighbor from the middle object of the current data block in a spiral order and removing objects which are considered as non-outliers from the currently detected data block; updating a TOP n outlier and the outlier degree threshold and turning to the next data block after all of the objects in the current data block have been processed.

Step S135, outputting the TOP n outlier after all of the data blocks have been processed.

In the embodiment, the algorithm is illustrated with the example of a pseudo code. Inputting: the quantity of the nearest neighbor k, the quantity of the outliers to be detected n, the data set D; outputting: the TOP n outlier. As such, the foregoing step S13 includes steps as follows.

After the establishment of the index, dividing the index data into data blocks (e.g. 1000 objects are considered as a data block), and calculating the data blocks to obtain the Hilbert code value increment and then sorting the data blocks in a descending order. Next, performing the outlier detection in the sorted data blocks, block by block to find out the outliers. With respect to each data block, at the very first of the outlier detection, the third pruning rule is applied to determine whether there is any possible for the data block to contain outliers or not. If not, directly turning to a next data block. If yes, searching for the nearest neighbor from the middle object of the current data blocks in a spiral order. With respect to each object in the to-be-detected data block B, the first pruning rule is used to determine whether there is any possible for the object to be an outlier. If not, removing it from the data block B, and turning to detect the next object. If yes, then continue to search the k-nearest neighbor thereof. Before calculating the distance between the neighbor object and the outlier-possible object, the second pruning rule is used to determine whether there is any possible for the neighbor object to be one of the k-nearest neighbors of the outlier-possible object. If not, then do not calculate the distance therebetween, and directly turn to detect the next object. If yes, then calculate the distance therebetween and try to update the k-nearest neighbor thereof. At the same time, determine whether the current outlier degree is smaller than the threshold c. If yes, then remove the object from the data block B as it would not be an outlier.

In the embodiment, the three pruning rules are as below:

(1) The first pruning rule: ruling out the non-outlier objects.

If dist (x, pᵢ)+dist(pᵢ, nnₖ(pᵢ, D))<c, wherein pᵢ∈ P;

then it is impossible for x to be an outlier;

in other words, the pivot pᵢ and the k-nearest neighbors thereof each have a distance from object x smaller than c, so that there are at least k objects within the range of radius c from the object x, and thus the outlier degree thereof is smaller than c.

(2) The second pruning rule: ruling out the non-k-nearest neighbor objects.

if ∥dist (xₜ, pᵢ)−dist (xⱼ, pᵢ) ∥>dist (xₜ, nnₖ, (xₜ, D)), wherein pᵢ∈ P;

then it is impossible for xⱼ to be the k-nearest neighbor of xₜ.

(3) The third pruning rule:

If dist (B, pᵢ)+dist (pᵢ, nnₖ, (pᵢ, D))<c, wherein pᵢ∈ P;

then none of the objects in the data block B is an outlier.

That is, there are k or more nearest neighbors within a distance c for each object in the data block B.

In the embodiment, in fact, lots of the objects in the data block may have been removed after a data block is done being preformed with detection. With respect to the rest objects, try to add them into the TOP n outlier one by one and update the outlier degree threshold c. Output the TOP n outlier after all of the data blocks have been detected.

In order to reduce the data space distortion, the technical solution provided by the present invention selects multiple pivots from the data set and then establishes an index with little time consumption (with respect to the total time consumption of outlier detection). In order to more rapidly increase the outlier degree threshold, the spare regions of the data set, including the remote region and other spare region, are detected preferentially. In order to improve the stability of the performance of the algorithm, a pivot selection algorithm in approximate dense region is provided, so that pivots with a better quality may be selected in a short time. In order to further reduce the calculating times of the distance and accelerate the outlier detection, multiple pruning rules are used to exclude the non-outliers and non k-nearest neighbor objects. The technical solution provided by the present invention establishes an index by calculating the distances between each of the selected multiple pivots and the global data set, avoiding the data space distortion caused by single pivot; furthermore, the preferential detection of the spare regions of the data set can increase the outlier degree threshold more rapidly and improve the speed of the outlier detection.

The technical solution provided by the present invention can provide a high detection speed and is compatible to various definitions of outliers while reserving the distance-based generality. The method for detecting outlier based on multiple pivots index provided by the present invention uses three pruning rules to rule out a large amount of non-outliers and non-k-nearest neighbor objects, reducing calculating times for the distance and improving the outlier detection speed.

The embodiments of the present invention also provide a system for detecting outlier based on multiple pivots index, mainly including:

a pivot selection module 11, configured to read a data set and select multiple pivots from the data set to form a pivot set;

an index establishment module 12, configured to calculate the distances between each object in the data set and the selected multiple pivots, and then use the distances as coordinates to form a multi-dimensional data space, and establish an index with the multi-dimensional data space;

an outlier detection module 13, configured to divide the index into a plurality of data blocks, and performing a detection on the data blocks for outliers, block by block.

The system 10 for detecting outlier based on multiple pivots index provided in the present invention establishes an index by calculating the distances between each of the multiple of selected pivots and the global data set, avoiding the data space distortion caused by single pivot; furthermore, the preferential detection on the spare regions of the data set can increase the outlier degree threshold more rapidly and improve the speed of the outlier detection.

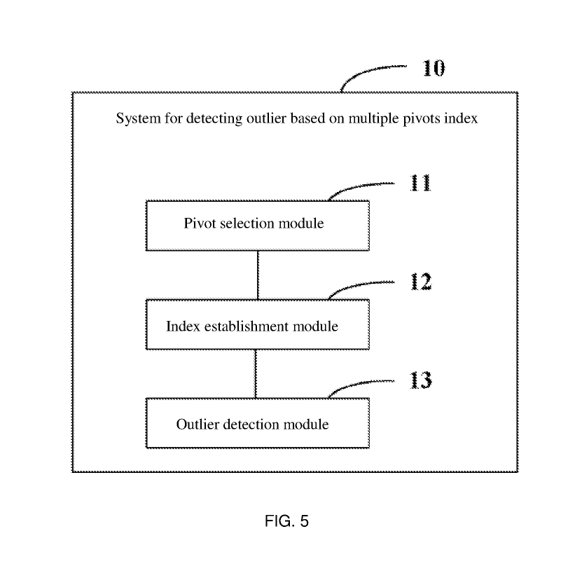

Referring to FIG. 5, which shows an internal structural diagram of the system 10 for detecting outlier based on multiple pivots index according to one embodiment of the present invention. In the embodiment, the system 10 for detecting outlier based on multiple pivots index mainly includes the pivot selection module 11, the index establishment module 12, and the outlier detection module 13.

The pivot selection module 11 is configured for reading a data set, and selecting multiple pivots from the data set to form a pivot set.

In the embodiment, the pivot selection module 11 is specifically configured for: randomly selecting an initial reference point after the reading the data set, and selecting a datum point with a farthest distance from the initial reference point; calculating the distance between each object of the data set and the datum point; sorting the objects of the data set by distances in an order from small to large; dividing the data set into a plurality of equidistance segments; sorting the plurality of segments by the quantity of the objects contained in the respective segments; determining whether the quantity of the objects contained in the segments are equal; adding midpoints of the quantities of the segments into the pivot set in an order when the quantities of the objects of the segments are unequal;

adding the midpoints of the quantities of the segments which are closer to the initial reference point into the pivot set when the quantities of the objects quantity of the segments are equal.

The index establishment module 12, configured for forming a multi-dimensional data space with the selected multiple pivots, and establishing an index with the multi-dimensional data space.

In the embodiment, the index establishment module 12 is specifically configured for:

selecting the pivots of corresponding quantity from the pivot set according to the dimensionality of the multi-dimensional data to be transformed;

mapping each object of the data set as a distance from the respective pivots, so as to form a multi-dimensional data space;

mapping the multi-dimensional data space as a plurality of integer coordinate values;

calculating a Hilbert code value of each pair of the integer coordinate values with the Hilbert index mapping algorithm;

sorting the obtained Hilbert code values to establish a Hilbert index

The outlier detection module 13, configured for dividing the index into data blocks and performing a detection on the data blocks for outlier, block by block.

In the embodiment, the outlier detection module 13 is specifically configured for:

dividing the Hilbert index into a plurality of data blocks, and sorting the plurality of data blocks based on the code values from spare to dense as an outlier detection order;

initializing a outlier degree threshold as 0, and reading the data set block by block based on the outlier detection order;

when there is no possible for any objects in the current data set to be considered as an outlier, turning to a next data block directly;

when there is possible for any object in the current data block to be considered as an outlier, searching for a nearest neighbor from the middle object of the current data blocks in a spiral order and removing objects which are considered as non-outliers from the current detected data blocks; updating a TOP n outlier and the outlier degree threshold after all of the objects in the current data block are processed, turning to the next data block;

outputting the TOP n outlier after all of the data blocks are processed.

In order to reduce the data space distortion, the system 10 for detecting outlier based on multiple pivots index provided by the present invention selects multiple pivots from the data set and then establishes an index with little time consumption (with respect to the total time consumption of outlier detection). In order to more rapidly increase the outlier degree threshold, the spare regions of the data set, including the remote region and other spare region, are detected preferentially. In order to improve the stability of the performance of the algorithm, a pivot selection algorithm in approximate dense region is provided, so that pivots with a better quality may be selected in a short time. In order to further reduce the calculating times of the distance and accelerate the outlier detection, multiple pruning rules are used to exclude the non-outliers and non k-nearest neighbor objects. The technical solution provided by the present invention establishes an index by calculating the distances between each of the selected multiple pivots and the global data set, avoiding the data space distortion caused by single pivot; furthermore, the preferential detection of the spare regions of the data set can increase the outlier degree threshold more rapidly and improve the speed of the outlier detection.

The system 10 for detecting outlier based on multiple pivot provided by the present invention has a high detection speed and is compatible to various definitions of outliers while reserving the distance-based generality. The system for detecting outlier based on multiple pivot provided by the present invention uses three pruning rules to rule out a large amount of non-outliers and non-k-nearest neighbor objects, reducing calculating times for the distance and improving the outlier detection speed.

It is to be noted that every unit described in the foregoing embodiments is merely divided according to its logical functions, but is not limited to the aforementioned division, as long as corresponding function can be implemented; besides, the specific names of the functional units are intended to distinguish them from each other, rather than to limit the protection scope of the present disclosure.

Additionally, as can readily be appreciated by one of ordinary skill in the art that all or part of the steps of the aforementioned embodiments may be implemented by hardware executed by algorithms. The algorithms may be stored in a computer readable storage medium such as ROM/RAM, disc, or light disk, etc.

The foregoing description are merely intend to illustrate preferred embodiments of the present disclosure, but not limit the scope of the present disclosure. Any modification, equivalent replacement or improvement made without departing from the spirit and principle of the present invention should fall within the scope of the present disclosure.

What is claimed is:

1. A method for detecting outlier based on multiple pivots index, comprising:
pivot selection step comprising reading a data set, and selecting multiple pivots from the data set to form a pivot set;
index establishment step comprising calculating distances between each object in the data set and the selected multiple pivots, and using the distances as coordinates to form a multi-dimensional data space, and establishing an index with the multi-dimensional data space;
outlier detection step comprising: dividing the index into a plurality of data blocks, and performing a detection on the data blocks for outliers, block by block.

2. The method for detecting outlier based on multiple pivots index according to claim 1, wherein the pivot selection step further comprises:
randomly selecting an initial reference point after reading the data set, and selecting a datum point with a farthest distance from the initial reference point;
calculating distances between each object of the data set and the datum point;
sorting the objects of the data set by the distances in an order from small to large;
dividing the data set into a plurality of segments with equal distance;
sorting the plurality of segments by quantities of the objects contained in the segments;
determining whether the quantity of the objects contained in the segments are equal or not;
when the quantities of the objects contained in the segments are unequal, adding midpoints of the quantities of respective segments into the pivot set in an order;
when the quantities of the objects contained in the segments are equal, preferentially adding a midpoint of the quantity of the segment which is closer to the initial reference point into the pivot set.

3. The method for detecting outlier based on multiple pivots index according to claim 2, wherein the index establishment step further comprises:
selecting pivots of corresponding quantity from the pivot set according to the dimensionality of the multi-dimensional data to be transformed;
mapping each object in the data set as a distance from the respective pivots, so as to form a multi-dimensional data space;
mapping the multi-dimensional data space as a plurality of integer coordinate values;
calculating a Hilbert code value of each pair of the integer coordinate values with a Hilbert index mapping algorithm;
sorting the plurality of obtained Hilbert code values in an order to establish a Hilbert index.

4. The method for detecting outlier based on multiple pivots index according to claim 3, wherein the outlier detection step further comprises:
dividing the Hilbert index into a plurality of data blocks, and sorting the plurality of data blocks based on the code values from spare to dense as an outlier detection order;
initializing an outlier degree threshold as 0, and reading the data set block by block in an outlier detection order;
when there is no possible for any objects in a current data set to be considered as an outlier, turning to a next data block directly;
when there is possible for any object in a current data set to be considered as an outlier, searching for a nearest neighbor from a middle object of the current data block in a spiral order and removing objects which are considered as non-outliers from the currently detected data block; updating a TOP n outlier and the outlier degree threshold and turning to the next data block after all of the objects in the current data block are processed;
outputting the TOP n outlier after all of the data blocks have been processed.

5. A system for detecting outlier based on multiple pivots index, comprising:
a pivot selection module, configured to read a data set and select a multiple pivots from the data set to form a pivot set;
an index establishment module, configured to calculate a distance between each object in the data set and the selected multiple pivots, and use the distances as a coordinates to form a multi-dimensional data space, and establish an index with the multi-dimensional data space;
an outlier detection module, configured to divide the index into a plurality of data blocks, and perform a detection on the data blocks for outliers, block by block.

6. The system for detecting outlier based on multiple pivots index according to claim 5, wherein the pivot selection module is further configured for:
randomly selecting an initial reference point after reading the data set, and selecting a datum point with a farthest distance from the initial reference point;
calculating distances between each object of the data set and the datum point;
sorting the objects of the data set by the distances in an order from small to large;
dividing the data set into a plurality of segments with equal distance;
sorting the plurality of segments by quantities of the objects contained in the segments;
determining whether the quantity of the objects contained in the segments are equal or not;
when the quantities of the objects contained in the segments are unequal, adding midpoints of the quantities of respective segments into the pivot set in an order;
when the quantities of the objects contained in the segments are equal, adding midpoints of the quantities of the segments into the pivot set in an order of distance to the initial reference point from small to large.

7. The system for detecting outlier based on multiple pivots index according to claim 6, wherein the index establishment module is specifically configured for:
selecting pivots of corresponding quantity from the pivot set according to the dimensionality of the multi-dimensional data to be transformed;
mapping each object in the data set as a distance from the respective pivots, so as to form a multi-dimensional data space;
mapping the multi-dimensional data space as a plurality of integer coordinate values;
calculating a Hilbert code value of each pair of the integer coordinate values with a Hilbert index mapping algorithm;
sorting the plurality of obtained Hilbert code values in an order to establish a Hilbert index.

8. The system for detecting outlier based on multiple pivots index according to claim 7, wherein the outlier detection module is specifically configured for:
dividing the Hilbert index into a plurality of data blocks, and sorting the plurality of data blocks based on the code values from spare to dense as an outlier detection order;
initializing an outlier degree threshold as 0, and reading the data set block by block in an outlier detection order;
when there is no possible for any objects in a current data set to be considered as an outlier, turning to a next data block directly;
when there is possible for any object in a current data set to be considered as an outlier, searching for a nearest neighbor from a middle object of the current data block in a spiral order and removing objects which are considered as non-outliers from the currently detected data block; updating a TOP n outlier and the outlier degree threshold and turning to the next data block after all of the objects in the current data block are processed;
outputting the TOP n outlier after all of the data blocks have been processed.
